(19) United States
(12) Patent Application Publication
(10) Pub. No.: US 2010/0154640 A1
(43) Pub. Date: Jun. 24, 2010

(54) Process and Honeycomb Body for Purifying and/or Regenerating Gases

(75) Inventors: Christoph Hagg, Graz (AT); Franz Kronabeter, Deutschlandsberg (AT); Alfred Schmuck, Deutschlandsberg (AT)

Correspondence Address: COHEN, PONTANI, LIEBERMAN & PAVANE LLP, 551 FIFTH AVENUE, SUITE 1210, NEW YORK, NY, 10176, US

(73) Assignee: Porzellanfabrik Frauenthal GmbH, Wien (AT)

(21) Appl. No.: 12/086,682

(22) PCT Filed: Dec. 15, 2006
(86) PCT No.: PCT/AT2006/000518

§ 371 Date: Jun. 16, 2008

(51) Int. Cl. B01D 46/12

(52) U.S. Cl. 95/286; 55/484

(57) ABSTRACT

Process for purifying and/or regenerating gases, in which the gas to be treated is fed to at least one layer of adjacently arranged prismatic honeycomb bodies (1) made of a ceramic material, which honeycomb bodies are provided with a plurality of channels (1′) which are parallel to one another and terminate in the end faces of the honeycomb bodies and through which the gas to be treated flows. The honeycomb bodies (1) are arranged in the layer at a predetermined lateral distance therebetween, which is fixed by two spacers (2) applied at two adjoining honeycomb body side walls (1″).

The invention relates to a process for purifying and/or regenerating gases, in which the gas to be treated is fed into at least one layer of side-by-side arranged prismatic honeycomb bodies, which are made of a ceramic material and are provided with a plurality of channels located parallel in respect to each other and terminate in the end faces of the honeycomb bodies and through which the gas to be treated flows. A prismatic honeycomb body made of a ceramic material for use in installations for purifying and/or regenerating gases is a further object of the invention.

Generally, such honeycomb bodies are produced in the form of prismatic honeycomb bodies with smooth lateral wall surfaces. This makes possible their tight, side-by-side placement in installations, in order to not wind up with undefined gaps between the honeycomb bodies. A large number of honeycomb bodies stacked side-by-side and in layers above each other undergoes a correspondingly large expansion at high temperatures. If, for example, the honeycomb bodies are installed closely together in a regenerating installation in the cold state, in which case they are often pressed together by insulating materials on their outsides, a high mechanical stress is created between the individual honeycomb bodies in the hot operating state. If the mechanical pressure on individual honeycomb bodies becomes too great, the ceramic structure fails and the honeycomb body breaks. If, on the one hand, in addition the mechanical stability is weakened because of chemical corrosion and, on the other hand, the coefficient of thermal expansion (CTE) is increased, this negative effect can appear more strongly, the honeycomb bodies break and their function as heat reservoirs is strongly negatively affected.

Various damage reports, or complaints regarding the use of ceramic honeycomb bodies which are for example employed as heat exchangers in RTO regeneration installations have shown that the honeycomb bodies are often packed too closely together in the top regenerator layers and therefore experience damage in the course of operation because of mechanical stresses. Ceramic materials used as heat reservoirs have a defined coefficient of thermal expansion (CTE) and expand differently in accordance with the temperatures in the various layers of a regenerator bed. It has been additionally observed that corrosion mechanisms can alter the ceramic material in the course of operation in such a way that the CTE increases in comparison with the state prior to the start of an operation. With large cross sections of the regenerator beds, which correspond to a large number of side-by-side packed honeycomb bodies, very strong mechanical forces, which lead to the destruction of the affected honeycomb layers, can therefore occur because of a corrosion-caused rise of the CTE, high operating temperatures and simultaneously too tight packing of the individual honeycomb bodies.

The following table shows various operating values:

TABLE 1
Expansion of Various Ceramic Honeycomb Bodies of the
Top Regenerator Bed Layer at Operating Temperature

| | Width of | Coefficient | | |
|---|---|---|---|---|
| Types of | honeycomb | of heat | | Honeycomb body |
| honeycomb | body L | expansion | Δ Tox-RT | expansion ΔL |
| bodies | [mm] | [1/K] | ° C. | [mm] |
| NT | 150 | 6.5E−06 | 850 | 0.8 |
| CR10 | 150 | 4.50E−06 | 850 | 0.6 |
| MK20 | 150 | 2.20E−06 | 850 | 0.3 |
| Attack by | 150 | 8.00E−06 | 850 | 1.0 |
| chemicals 1 | | | | |
| Attack by | 150 | 9.00E−06 | 850 | 1.1 |
| chemicals 2 | | | | |

The honeycomb bodies can break as a result of too strong a mechanical pressure, caused by heat-expansion and too tight packing. The honeycomb bodies are, for example, laterally bordered by cement segments and have no possibility for expansion except to the side facing the insulation.

It is the aim of the invention to avoid the above explained problems and to create a honeycomb body structure which provides a defined distance of the honeycomb bodies from each other already at the time of installation, in particular in the uppermost layers, in order to make heat expansion possible.

The object of the invention is a process of the type mentioned at the outset, which is distinguished in that the honeycomb bodies are arranged in the layer with a predetermined mutual lateral distance, which is fixed by spacers applied to two lateral walls of honeycomb bodies bordering each other.

Spacers, which are preferably made of a combustible material, are preferably applied to two lateral walls, bordering each other, of each honeycomb body.

A further object of the invention is a honeycomb body made of a ceramic material for use in installations for purifying and/or regenerating gases, having a prismatic body through which a plurality of gas flow channels passes and which terminate in both front sides of the honeycomb body. The honeycomb body in accordance with the invention is distinguished in that at least two adjoining lateral walls of each honeycomb body are structured to be definitely uneven.

The application in accordance with the invention of such ceramic honeycomb bodies has as a result, that in the course of installation in, for example, a regenerator bed, a spacing corresponding to the uneven lateral wall structure is created between the honeycomb bodies on all four sides of a honeycomb body of each layer of beds.

Within the framework of the invention, spacers, which are preferably made of a combustible material, are attached to two adjoining lateral walls of each honeycomb body. Alternatively it is possible for the spacers to be constituted by bulges in the lateral walls of the honeycomb bodies.

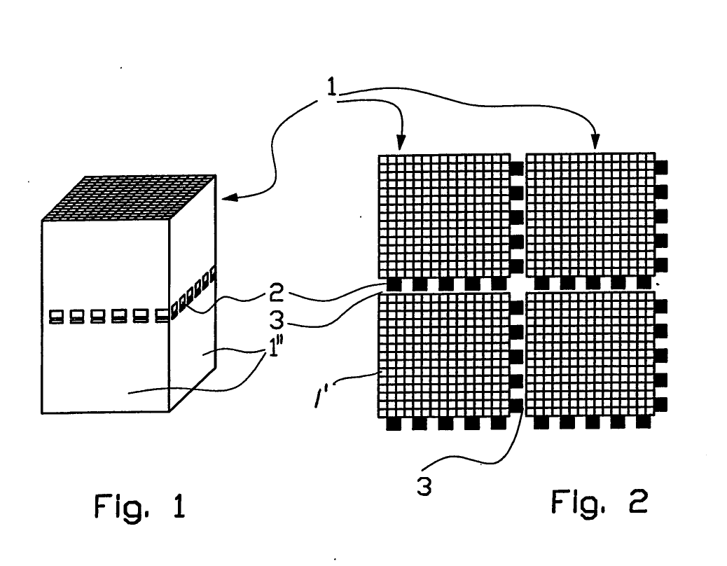

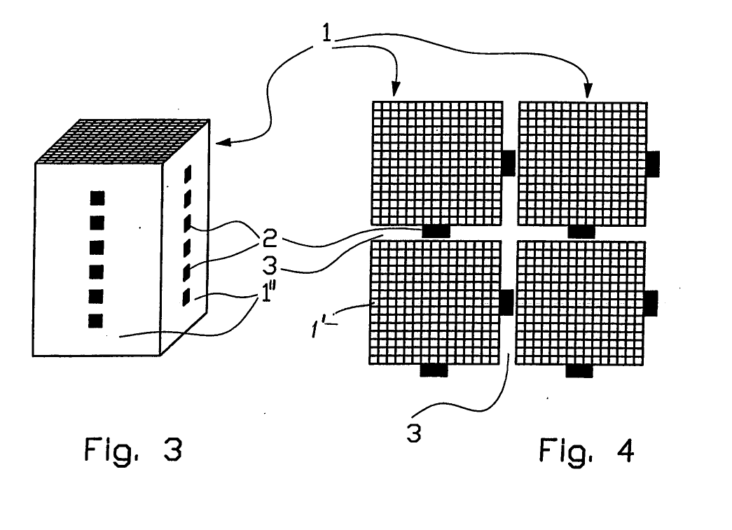

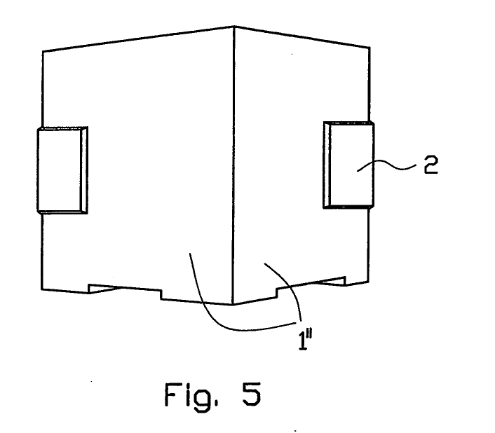

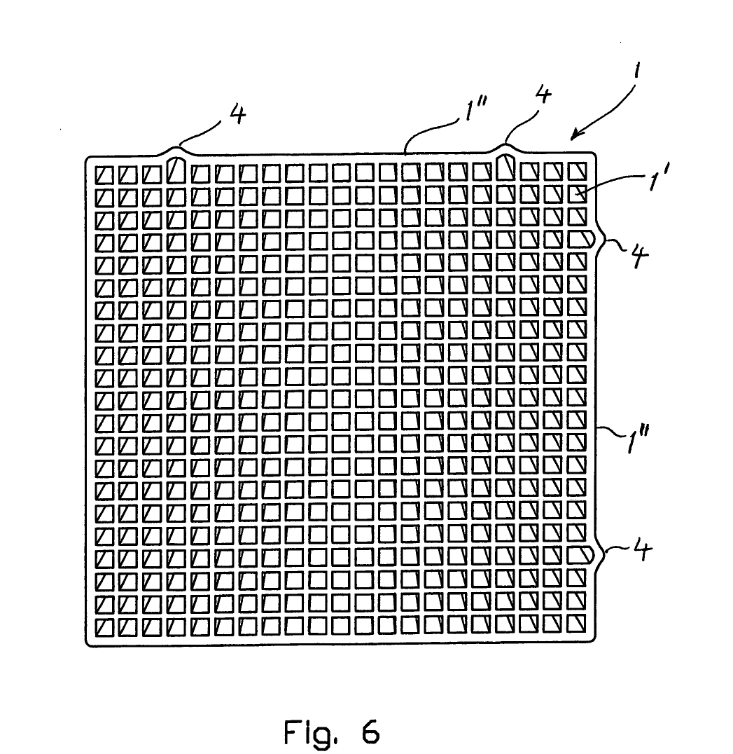

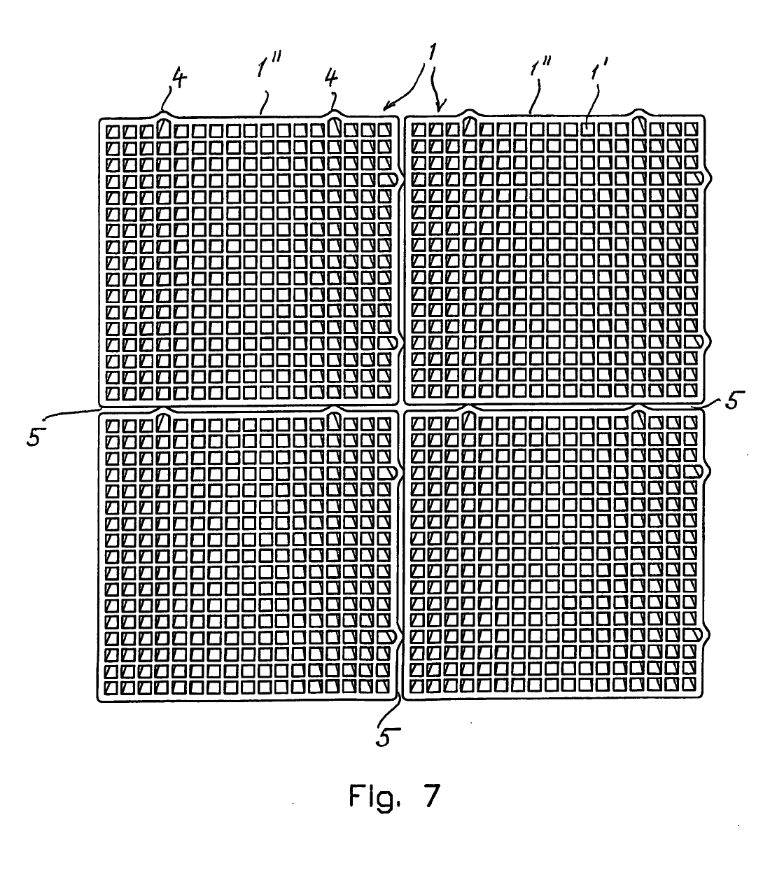

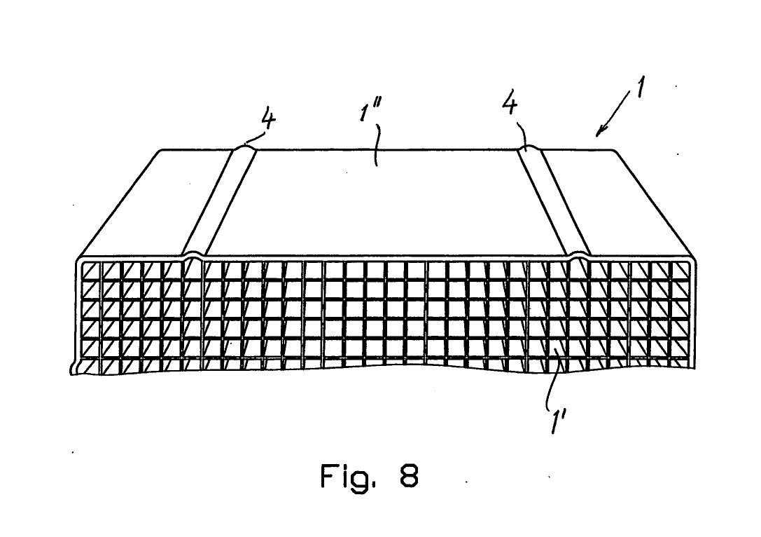

In what follows, the invention will be explained in greater detail by means of an exemplary embodiment, making reference to the drawings, which schematically represent different honeycomb bodies in accordance with the invention and illustrate their installation in, for example, a regenerator bed. FIG. 1 is a schematic plan view of a first type of embodiment of a honeycomb body, FIG. 2 shows a honeycomb body in a view from above, FIG. 3 shows a second embodiment of the invention, FIG. 4 illustrates the installation of the honeycomb body in accordance with FIG. 3 in a view from above, FIG. 5 shows a third embodiment, FIG. 6 a fourth embodiment, FIG. 7 the installation of the fourth embodiment in a view from above, and FIG. 8 a detail in connection with FIG. 6.

In accordance with FIG. 1, following the firing process, spacers made of paper, cardboard, plastic, metal or other materials, are fastened vertically or horizontally by gluing to at least two lateral walls 1″ of the honeycomb body 1 extruded from a ceramic material and having a plurality of channels 1′. This embodiment has the result that during the operation at high temperatures the spacer 2 applied at a later time is burned. The gap 3 between the honeycomb bodies arranged in a layer of, for example, a regenerator bed, is reduced during the operation in accordance with the heat expansion of the ceramic material.

In accordance with FIGS. 6 to 8, the desired structure of the honeycomb body lateral wall 1″ is fixed by the shape of the extruding tool. The initially flat lateral wall of the honeycomb body 1 is determined in the extruding tool by milling the outside of the tool core and an appropriate slit-generating frame.

A defined bulge 4 of at least two lateral walls 1″ has the result that, in the course of the installation of the honeycomb bodies 1 in the cold state of the installation, defined free spaces 5 are created between the honeycomb bodies. Following start-up and heating of the regenerator bed, the honeycomb bodies can expand free of tension in accordance with their coefficient of heat expansion. The spacers 2 are burned or, in the case of the structured lateral wall 1″, break (predetermined break line).

The installation of honeycomb bodies at defined distances from each other additionally offers the use of the lateral wall surface of the honeycomb body as a heat-exchange surface. With honeycomb bodies of a height of 300 mm, this corresponds to a surface of approximately 26.6 m²/m². Referring to the active surface of various honeycomb body types, this can cause an increase in the active heat-exchange surface of 2% (60×60 cells) to 5% (25×25 cells).

1. A process for purifying and/or regenerating gases, in which the gas to be treated is fed into at least one layer of side-by-side arranged prismatic honeycomb bodies, which are made of a ceramic material and are provided with a plurality of channels located parallel in respect to each other and terminate in the end faces of the honeycomb bodies and through which the gas to be treated flows, wherein the process comprises arranging the honeycomb bodies in the layer with a predetermined lateral distance therebetween, which is fixed by spacers applied to two adjoining lateral walls of honeycomb bodies.

2. The process in accordance with claim 1, wherein spacers, which are made of a combustible material, are applied to two lateral walls, adjoining each other, of each honeycomb body.

3. A honeycomb body made of a ceramic material for use in installations for purifying and/or regenerating gases, having a prismatic body, through which a plurality of gas flow channels pass, which terminate in both front sides of the honeycomb body, wherein at least two adjoining lateral walls (1″) of the honeycomb body (1) are structured to be uneven.

4. The honeycomb body in accordance with claim 3, wherein the honeycomb body lateral walls (1″) are provided with spacers (2, 4).

5. The honeycomb body in accordance with claim 4, wherein the spacers are constituted by separately attached elements (2).

6. The honeycomb body in accordance with claim 4, wherein the spacers comprise bulges (4) in the honeycomb body lateral wall (1″).

7. The honeycomb body in accordance with claim 5, wherein the separately attached elements are made of a combustible material.
